(19) United States
(12) Patent Application Publication
(10) Pub. No.: US 2008/0223872 A1
(43) Pub. Date: Sep. 18, 2008

(54) Small item dispenser

(76) Inventors: Thomas E. Kramer, Coon Rapids, MN (US); Matthew H. Rust, Hudson, WI (US); Alan Webb, Prior Lake, MN (US)

Correspondence Address: MERCHANT & GOULD PC, P.O. BOX 2903, MINNEAPOLIS, MN, 55402-0903, US

(21) Appl. No.: 11/717,611

(22) Filed: Mar. 13, 2007

(51) Int. Cl. G07F 11/16

(52) U.S. Cl. 221/265

(57) ABSTRACT

A dispenser for dispensing small items such as pieces of candy is disclosed herein. The dispenser includes an outer housing and an inner housing slidably coupled to the outer housing, the outer housing and the inner housing defining a main cavity thereinbetween. The dispenser includes a pocket within the inner housing that can be separated from the main cavity by slidable movement of the inner housing with respect to the outer housing. The outer housing includes a divider for at least substantially blocking off the pocket from the main cavity when the inner housing moves from a closed position to an open position such that small items cannot enter the pocket. When the inner housing is in the closed position, a small item can enter the pocket but cannot be accessed from outside the small item dispenser, and, when the inner housing is in the open position, the pocket can be accessed from outside the small item dispenser without small items being able to enter the pocket from the main cavity.

### TECHNICAL FIELD

The present invention relates generally to dispensers. More particularly, the present invention relates to dispensers for dispensing small items such as pieces of candy.

### BACKGROUND

Containers for storing and dispensing small items such as tablets or pieces of candy are well known. Some examples of small item dispensers may include a removable screw top, a peelable seal, a slidable cover, or a snap-fit cap or opening. Once these closures are opened, the items within the containers may be freely poured from the container. One problem often encountered with the dispensers found in the art is that their designs make it difficult for users to control the amount of items to be dispensed from the container. A person wanting one, two, or a few tablets or pieces of candy often has a difficult time controlling the amount of items dispensed from the container and usually has to resort to discarding the unwanted pieces.

### SUMMARY

One aspect of the present disclosure relates to a dispenser adapted for easily dispensing small items such as pieces of candy. In one example embodiment, the dispenser includes an outer housing and an inner housing slidably coupled to the outer housing, the outer housing and the inner housing defining a main cavity thereinbetween. The dispenser includes a pocket within the inner housing that can be separated from the main cavity by slidable movement of the inner housing with respect to the outer housing. The outer housing includes a divider for at least substantially blocking off the pocket from the main cavity when the inner housing moves from a closed position to an open position such that small items cannot enter the pocket when the inner housing is in the open position. When the inner housing is in the closed position, a small item can enter the pocket but cannot be accessed from outside the small item dispenser, and, when the inner housing is in the open position, the pocket can be accessed from outside the small item dispenser without small items being able to enter the pocket from the main cavity.

Examples representative of a variety of inventive aspects are set forth in the description that follows. The inventive aspects relate to individual features as well as combinations of features. It is to be understood that both the forgoing general description and the following detailed description merely provide examples of how the inventive aspects may be put into practice, and are not intended to limit the broad spirit and scope of the inventive aspects.

### BRIEF DESCRIPTION OF THE DRAWINGS

FIG. 1 is a rear perspective view of a dispenser in accordance with the principles of the present disclosure;

FIG. 2 is a right side elevational view of the dispenser of FIG. 1;

FIG. 3 is a top plan view of the dispenser of FIG. 1;

FIG. 4 is a bottom plan view of the dispenser of FIG. 1;

FIG. 5 is a front elevational view of the dispenser of FIG. 1;

FIG. 6 is a rear perspective view of the dispenser of FIG. 1, the internal features of the dispenser shown with hidden lines;

FIG. 7 is a right side elevational view of the dispenser of FIG. 6;

FIG. 7A is a close-up view of a portion of the dispenser of FIG. 7;

FIG. 7B illustrates the dispenser of FIG. 7 in an open position;

FIG. 8 is a cross-sectional view taken along line 8-8 of FIG. 7;

FIG. 9 is a rear perspective view of an outer housing of the dispenser of FIG. 1, the internal features of the outer housing shown with hidden lines;

FIG. 10 is a right side elevational view of the outer housing of FIG. 9;

FIG. 11 is a front elevational view of the outer housing of FIG. 9;

FIG. 12 is a top plan view of the outer housing of FIG. 9;

FIG. 13 is a bottom plan view of the outer housing of FIG. 9;

FIG. 14 is a rear perspective view of an inner housing of the dispenser of FIG. 1;

FIG. 15 is a right side elevational view of the inner housing of FIG. 14;

FIG. 16 is a rear elevational view of the inner housing of FIG. 14;

FIG. 17 is a front elevational view of the inner housing of FIG. 14;

FIG. 18 is a top plan view of the inner housing of FIG. 14; and

FIG. 19 is a bottom plan view of the inner housing of FIG. 14.

### DETAILED DESCRIPTION

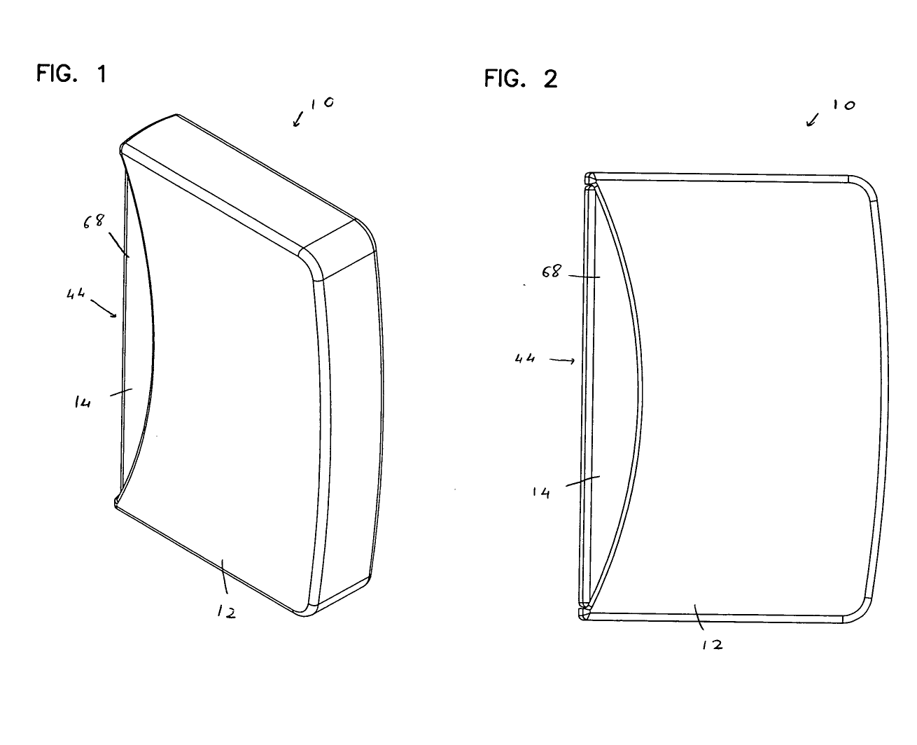

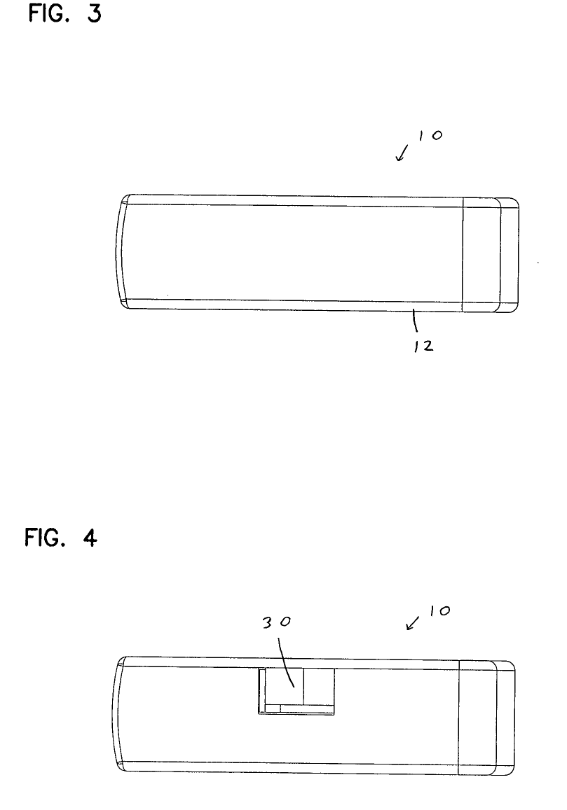

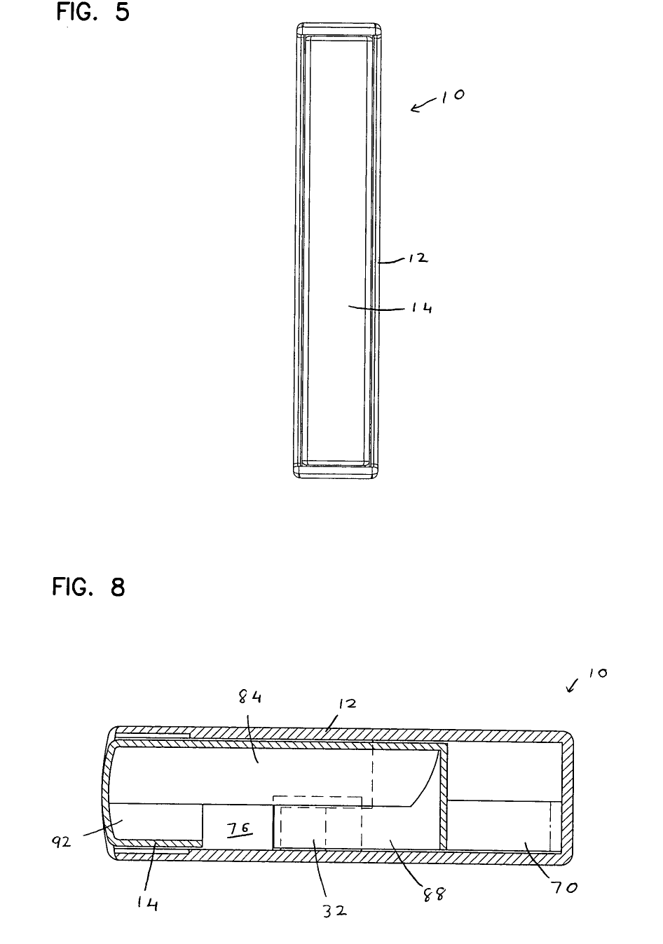

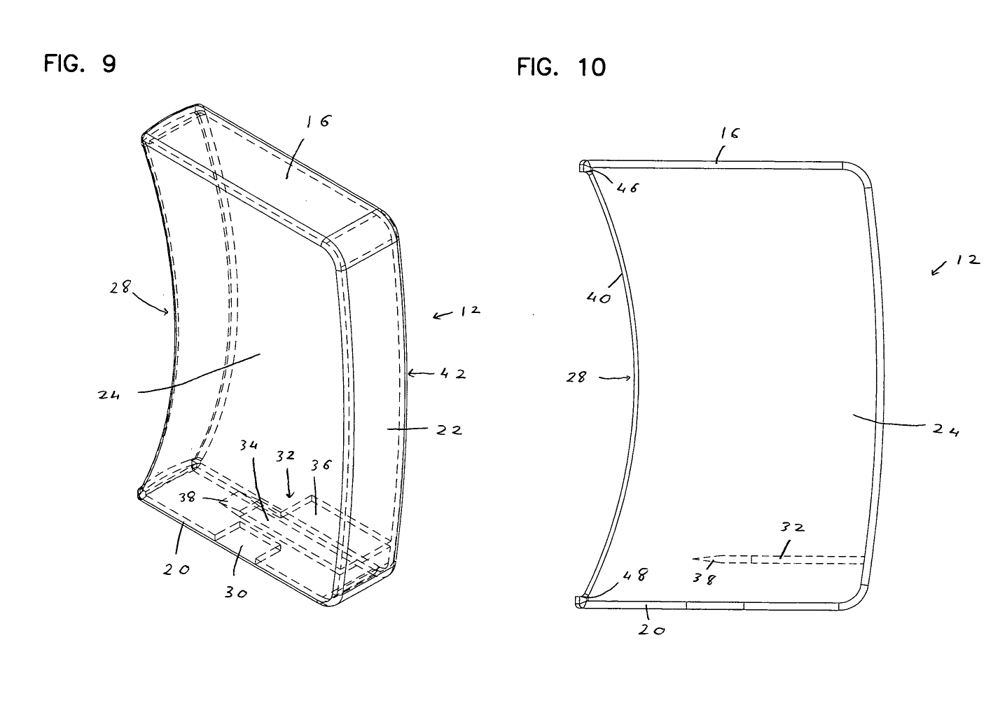

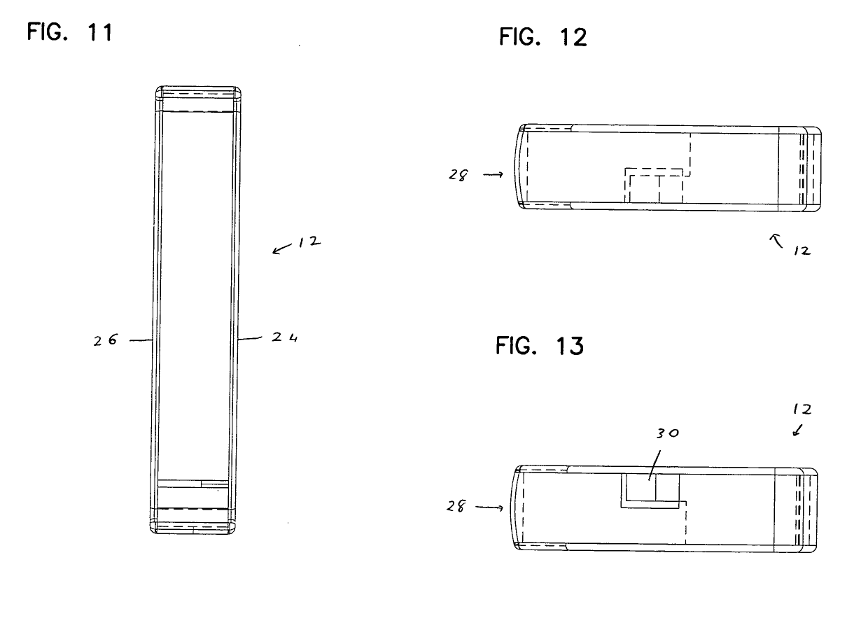

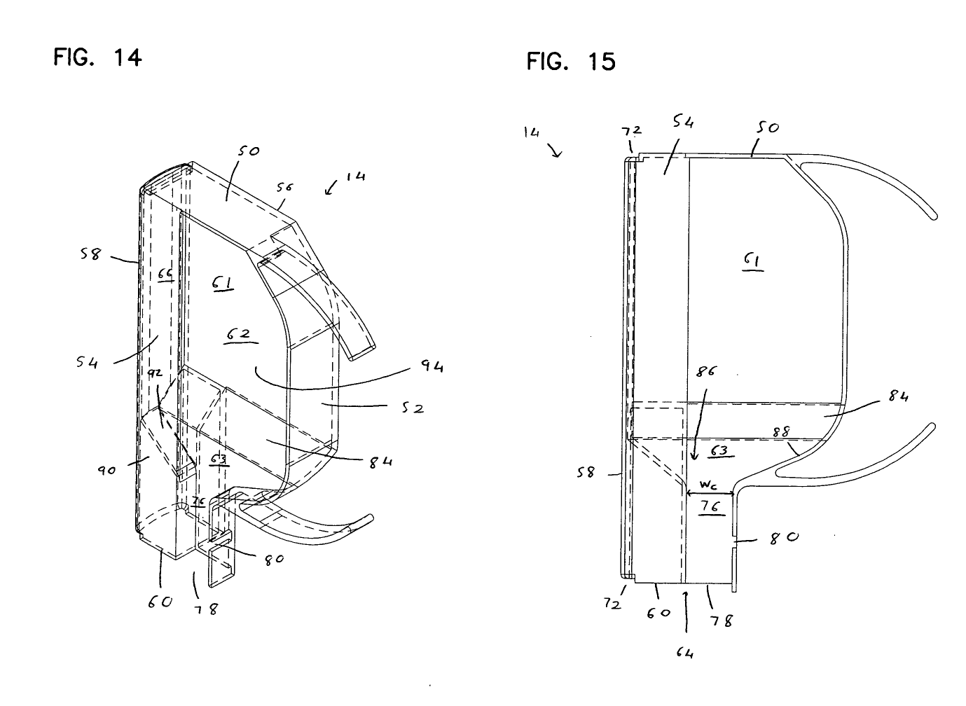

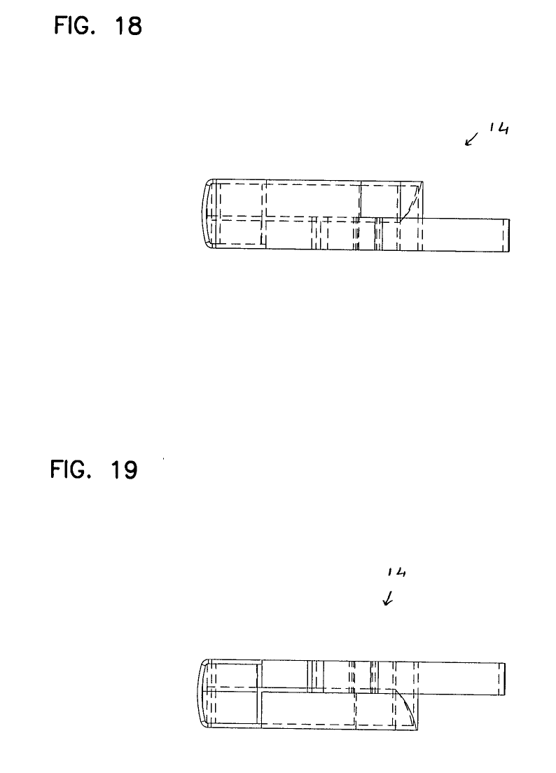

FIGS. 1-8 illustrate a dispenser 10 in accordance with the principles of the present disclosure. The dispenser 10 includes an outer housing 12 and an inner housing 14. The outer housing 12 is shown in greater detail in FIGS. 9-13 and the inner housing 14 is shown in greater detail in FIGS. 14-19. The inner housing 14 is configured to be inserted into the outer housing 12 after being loaded with small items 18 to be dispensed. As will be discussed in further detail below, when the dispenser 10 is assembled, the inner housing 14 is configured to slide with respect to the outer housing 12 for individually dispensing the small items 18 stored within the dispenser.

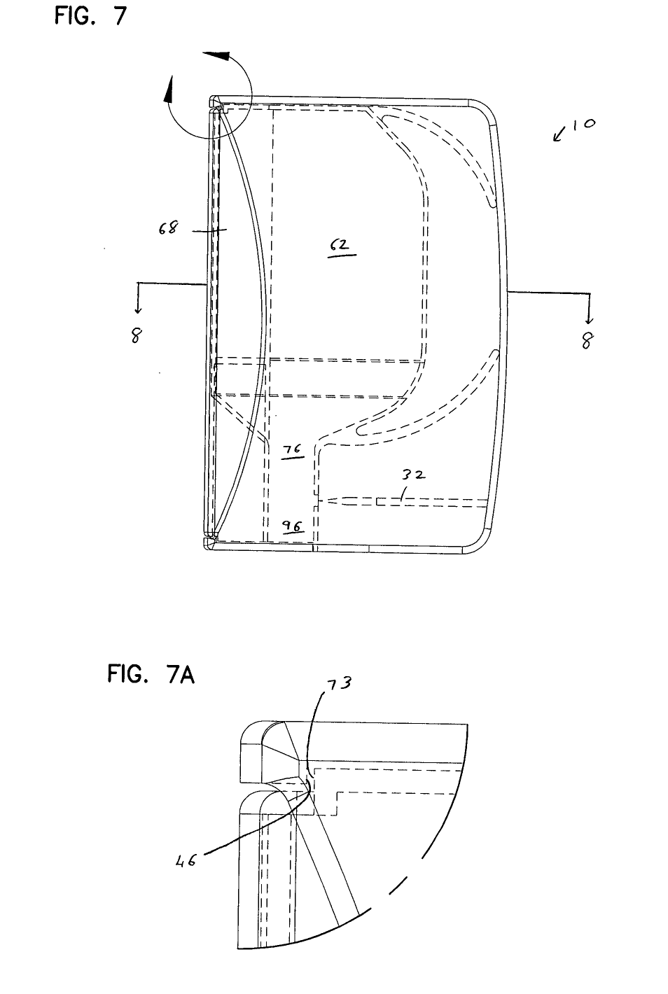

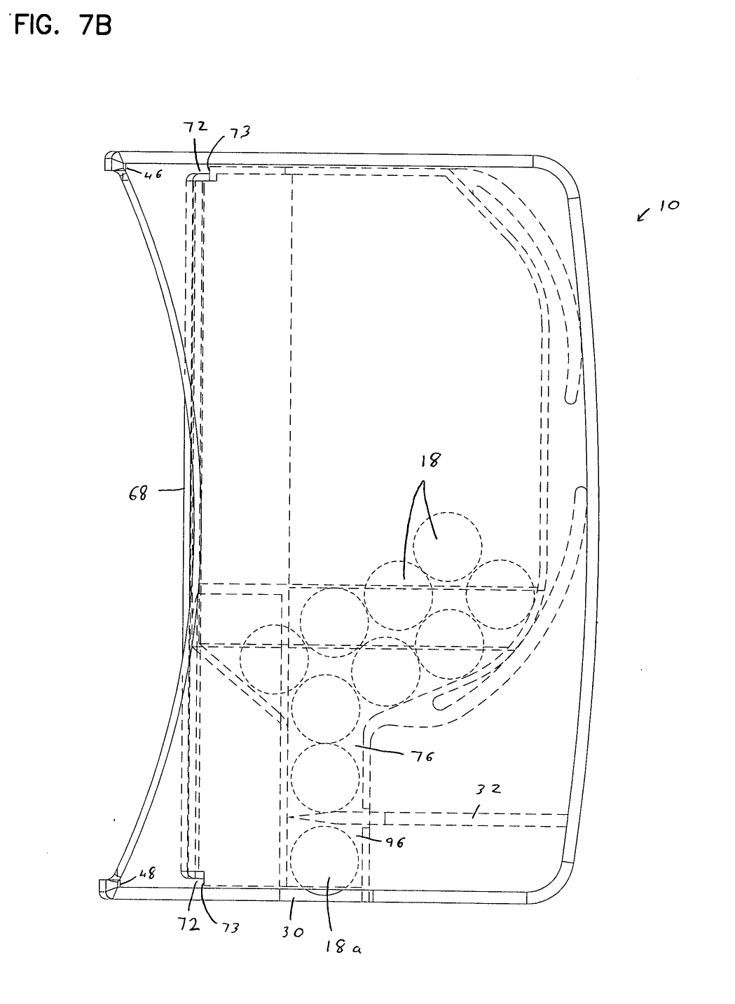

It will be appreciated that a variety of different types of items 18 can be dispensed from the dispenser 10 (see FIG. 7B). Preferred items 18 include pieces of candy. In one embodiment, the pieces of a candy can include pieces of hard candy. In a preferred embodiment, the items 18 can include liquid filled (e.g., mint filled) candy. In one example embodiment, the items 18 can include balls or spheres of candy including outer gelatin coatings and an inner liquid candy filling (e.g., a mint filling).

Referring to FIGS. 9-13, the outer housing 12 includes a generally rectangular configuration with a top wall 16, a bottom wall 20, a rear wall 22, a right sidewall 24, a left sidewall 26, and an open front end 28. The right and left sidewalls 24, 26 define major sides of the outer housing 12. As defined herein, the term “major side of the outer housing” is a side having a larger surface area than the other sides of the outer housing 12.

The outer housing 12 includes a dispensing opening 30 defined at the bottom wall 20. The dispensing opening 30 is used for dispensing items 18 stored within the dispenser 10. The outer housing 12 also includes a divider 32 extending from the rear wall 22 toward the front open end 28. As shown in FIG. 9, the divider 32 includes a first longer portion 34 and a second rearwardly offset shorter portion 36. The longer portion 34 is configured to extend over the dispensing opening 30. The longer portion 34 is adjacent the right sidewall 24 of the outer housing 12. The shorter portion 36 is located between the longer portion 34 and the left sidewall 26 of the outer housing 12. As will be discussed in further detail below, when the inner housing 14 is slidably moved relative to the outer housing 12, the divider 32 is configured to separate one small item from a remainder of the plurality of small items within the dispenser 10 in dispensing that single item.

Referring to FIGS. 9 and 10, in the depicted embodiment, the longer portion 34 of the divider 32 includes a pointed tip 38. The pointed tip 38 is configured to facilitate the separation of two adjacent small items 18 as the inner housing 14 is slid with respect to the outer housing 12. For example, in an embodiment housing small items 18 that include balls or spheres of candy, the pointed tip 38 follows the outer contour of the small items 18 and facilitates separating the items.

Still referring to FIGS. 9 and 10, the open front end 28 of the outer housing 12 defines a generally curved shape 40 that is concave toward the rear end 42 of the outer housing 12. As will be discussed in further detail below, the curvature of the open front end 28 allows the inner housing 14 of the dispenser 10 to be exposed to the outside of the dispenser 10 at a front end 44 of the dispenser. In this manner, the inner housing 14 can be grasped, squeezed, and slidably moved with respect to the outer housing 12 for dispensing small items 18 from the dispenser 10.

Referring to FIG. 10, the outer housing 12 defines an upper lip 46 and a lower lip 48 adjacent the open front end 28 of the outer housing 12. In assembling the dispenser 10, once the inner housing 14 is inserted within the outer housing 12, the upper and the lower lips 46, 48 are configured to contact portions of the inner housing 14 to prevent the inner housing 14 from separating from the outer housing 12 (see FIGS. 7 and 7A). And, once the dispenser 10 is assembled, the inner housing 14 is biased toward the open front end 28 of the outer housing 12.

Now referring to FIGS. 14-19, the inner housing 14 includes a top wall 50, a rear wall 52, a right sidewall 54, a left sidewall 56, a front wall 58, and a bottom wall 60. The left sidewall 56 defines a major side of the inner housing 14. As defined herein, the term “major side of the inner housing” is a side having a larger surface area than the other sides of the inner housing 14.

The inner housing 14 defines a main cavity 62 for storing the small items 18 to be dispensed by the dispenser 10. In the depicted embodiment, the main cavity 62 includes portions extending all the way from the rear wall 52 to the front wall 58 and from the top wall 50 to a bottom side 64 of the inner housing 14. As illustrated in FIG. 14, a portion 66 of the main cavity 62 is tucked behind the right sidewall 54 of the dispenser 10, communicating with the front wall 58 of the dispenser 10.

As shown in FIGS. 1, 2, 6, and 7, the front wall 58 and portions of the right sidewall 54 and the left sidewall 56 of the inner housing 14 protrude out from the outer housing 12 when the dispenser 10 is assembled. The protruding portion of the inner housing 14 defines a button 68 that is configured to be pressed to slide the inner housing 14 rearwardly with respect to the outer housing 12 in dispensing small items.

Referring to FIGS. 7, 14, and 15, the rear wall 52 of the inner housing 14 includes biasing members 70 extending out therefrom. When the dispenser 10 is assembled (i.e., when the inner housing 14 is slidably placed within the outer housing 12), the biasing members 70 contact the rear wall 22 of the outer housing 12 and bias the inner housing 14 toward the open front end 28 of the outer housing 12. In the depicted embodiment, the rear wall 52 of the inner housing 14 defines a curved configuration for accommodating the biasing members 70 when the biasing members 70 flex inwardly after contacting the rear wall 22 of the outer housing 12.

As discussed previously and as shown in FIGS. 7 and 7A, the front button portion 68 of the inner housing 14 includes indentations 72 adjacent the top and bottom ends thereof. The indentations 72 include vertical surfaces 73 configured to make contact with the lips 46, 48 of the outer housing 12 to keep the inner housing 14 within the outer housing 12. In this manner, even though the inner housing 14 is biased toward the open front end 28 of the outer housing 12, the inner housing 14 stays positioned within the outer housing 12.

When the inner housing 14 is at a frontmost position with respect to the outer housing 12, the dispenser 10 can be referred to herein as being in a closed position. In the closed position of the dispenser 10, small items 18 are not accessible from outside the dispenser 10. The closed position is shown in FIGS. 1, 2, 6, and 7. The inner housing 14 can be slidably moved to an open position (i.e., small item dispensing position) by squeezing the front button portion 68 of the inner housing 14 toward the rear of the outer housing 12. The open position (see FIG. 7B) of the dispenser 14 may be defined as the position wherein small items 18 are accessible from an outside of the dispenser 10.

Referring now to FIGS. 14 and 15, the main cavity 62 defines a narrower channel portion 76 as the main cavity 62 extends toward the bottom end 64 of the inner housing 14. The channel 76 defines an open end 78 at the bottom end 64 of the inner housing 14. The rear wall 52 of the inner housing 14 defines a slit 80 communicating with the channel portion 76. As will be discussed in further detail below, the slit 80 is configured to accommodate the divider 32 of the outer housing 12 when the inner housing 14 is slidably moved toward the rear end of the outer housing 12. In this manner, the divider 32 can separate a small item 18 to be dispensed from the remainder of the small items in the channel 76.

Referring to FIG. 15, in the depicted embodiment, the channel 76 defines a width W_{C}. In one example embodiment, the width W_{C} of the channel 76 is sized such that only a single column of items 18 can be provided within the channel 76 in a widthwise direction from front to rear. For example, in one embodiment, the width W_{C} is less than two times the diameter of the items 18 (e.g., spheres) held within the dispenser 10. In a preferred embodiment, the width W_{C} is only slightly larger than the diameter of the items 18 held within the dispenser 10.

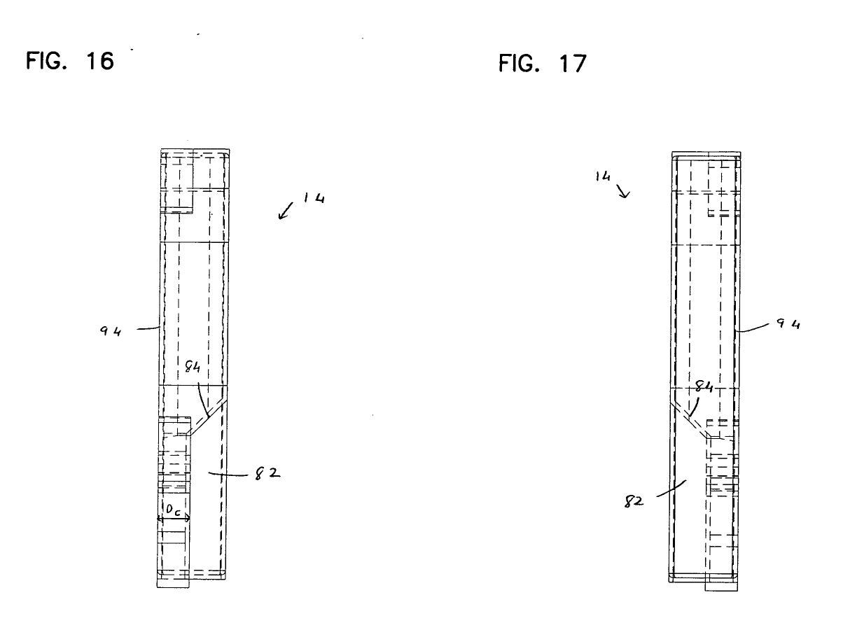

Referring now to FIGS. 16 and 17, in the depicted embodiment, the channel 76 is also preferably sized to hold only a single layer of items in a direction extending from the right side to the left side of the dispenser 10. In the depicted embodiment, the channel 76 defines a depth D_{C} that is sized such that only a single layer of items 18 can be provided within the channel 76. For example, in one embodiment, the depth D_{C} is less than two times the diameter of the items 18 (e.g., spheres) held within the dispenser 10. In a preferred embodiment, the depth D_{C} is only slightly larger than the diameter of the items 18 held within the dispenser 10.

Still referring to FIGS. 16 and 17, the inner housing 14 includes a bulkhead 82 with an angled surface 84 adjacent the left sidewall 56 of the inner housing 14 (see also FIGS. 14 and 15). The angled surface 84 is configured to direct small items 18 toward a narrower depth portion 63 of the main cavity 62 adjacent the channel 76. With gravity, the angled surface 84 of the bulkhead 82 directs small items 18 from an upper portion 61 of the main cavity 62 that can support multiple layers toward the channel 76 that preferably holds only a single layer of small items 18.

Referring to FIGS. 14 and 15, the inner housing 14 also defines a funnel structure 86 for directing small items 18 toward the channel 76 from the front and rear ends of the dispenser 10. As shown, the rear wall 52 includes a curved portion 88 configured for directing items from the upper wider portion 61 of the main cavity 62 toward the channel 76. In addition, adjacent the front end of the inner housing 14, the inner housing 14 includes a second bulkhead 90 with an angled surface 92 extending downwardly from the front wall 58 to the channel 76. The angled surface 92 is configured to direct small items 18 from the upper wider portion 61 of the main cavity 62 toward the channel 76. The angled surface 92 and the curved portion 88 of the rear wall 52 together form the funnel structure 86 of the inner housing 14.

Referring to FIG. 14, the main cavity 62 of the inner housing 14 includes an open right side 94. Small items 18 can be loaded into the main cavity 62 of the inner housing 14 from the right side 94 when the inner housing 14 is separated from the outer housing 12. Once the small items 18 are loaded, the inner housing 14 is inserted into the outer housing 12 from the open front end 28 of the outer housing 12.

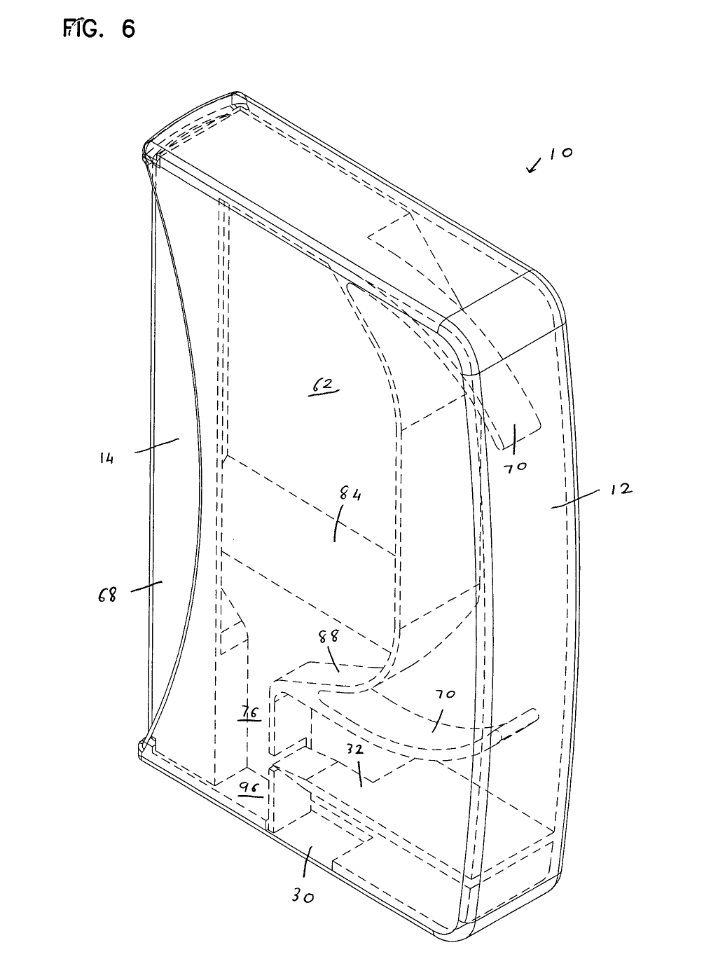

Once the dispenser 10 is assembled, the open right side 94 of the inner housing 14 is closed off by the right sidewall 24 of the outer housing 12. The open end 78 of the channel 76 is also closed off by the bottom wall 20 of the outer housing 12 when the inner housing 14 is at the closed position (see FIGS. 6 and 7). When the dispenser 10 is assembled, a pocket 96 is defined adjacent the bottom end 78 of the channel 76. Although the pocket 96 can be sized to hold any number of small items 18 (depending upon the size of the small items stored in the dispenser), according to one preferred embodiment, the pocket 96 is sized relative to the small items 18 such that it can hold exactly one small item 18. In such an embodiment, as depicted, the dispenser 10 allows the items 18 to be individually dispensed.

As discussed above, when the dispenser 10 is held in a vertical orientation such that gravity acts on the small items 18, the small items in the main cavity 62 are directed or funneled toward the channel 76, with one small item 18a ending up in the pocket 96. When the inner housing 14 is slidably moved with respect to the outer housing 12, the pocket 96 is moved and aligns with the dispensing opening 30 of the outer housing 12. As the inner housing 14 is slid, the divider 32 of the outer housing 12 moves through the slit 80 and closes off the pocket 96 from the rest of the main cavity 62. The divider 32 moves between the small item 18a to be dispensed and an adjacent small item 18 in the channel 76. Once the divider 32 moves past the small item 18a to be dispensed, the pocket 96 is sealed from the rest of the main cavity 62. Other small items 18 cannot enter the pocket 96 until the pocket 96 is opened again by the biased movement of the inner housing 14 with respect to the outer housing 12.

When the inner housing 14 is normally in the closed position (see FIGS. 6 and 7), an item 18 can enter the pocket 96 of the channel 76 from the main cavity 62, but is not accessible from outside the dispenser 10. When the inner housing 14 is moved against bias to the open position (see FIG. 7B), the dispensing opening 30 aligns with the pocket 96 such that an item 18a within the pocket 96 can be dispensed through the opening 30, with the divider 32 of the outer housing 12 preventing other small items 18 from entering the pocket 96. In this manner, by slidably moving the inner housing 14 back and forth between the closed and open positions, multiple items 18 can be dispensed, preferably, one at a time, through the opening 30.

Although in the foregoing description of the small item dispenser 10, terms such as “top”, “bottom”, “upper”, “lower”, “front”, “rear”, “right”, and “left” were used for ease of description and illustration, no restriction is intended by such use of the terms.

The above specification provides examples of how certain inventive aspects may be put into practice. It will be appreciated that the inventive aspects can be practiced in other ways than those specifically shown and described herein without departing from the spirit and scope of the inventive aspects.

We claim:

1. A small item dispenser comprising:
a first portion and a second portion slidably disposed with respect to the first portion, the second portion slidable between a closed position and an open position, the first portion including a first major side and the second portion including a second major side;
a main cavity for holding small items positioned between the first and second major sides; and
a pocket separable from the main cavity by slidable movement of the second portion with respect to the first portion from a closed position to an open position, wherein the pocket communicates with the main cavity for receiving at least one small item when the second portion is in the closed position and wherein the pocket is not accessible from an outside of the small item dispenser when the second portion is in the closed position;
wherein, when the second portion is moved from the closed position to the open position, the pocket becomes substantially blocked off from the main cavity and the pocket becomes accessible from the outside of the small item dispenser.

2. A small item dispenser according to claim 1, wherein at least a portion of the second portion is slidably inserted into the first portion.

3. A small item dispenser according to claim 1, wherein the first portion includes an access opening configured to communicate with the pocket when the second portion is moved to the open position.

4. A small item dispenser according to claim 1, wherein the second portion is biased toward a closed position with respect to the first portion.

5. A small item dispenser according to claim 1, wherein the second portion is separable from the first portion for loading small items into the main cavity.

6. A small item dispenser according to claim 1, wherein the pocket is sized to receive and hold at most one small item.

7. A small item dispenser according to claim 1, wherein small items are dispensed in a direction generally parallel to the first and second major sides.

8. A small item dispenser comprising:
an outer housing;
an inner housing slidably coupled to the outer housing, the inner housing and the outer housing defining a main cavity thereinbetween for holding small items, the inner housing movable with respect to the outer housing between a closed position and an open position; and
a pocket within the inner housing that can be separated from the main cavity, the pocket sized to receive and hold at least one small item;
wherein the outer housing includes a divider for at least substantially blocking off the pocket from the main cavity when the inner housing moves from the closed position to the open position such that small items cannot enter the pocket, and, wherein, when the inner housing is in the closed position, the at least one small item can enter the pocket but cannot be accessed from outside the small item dispenser, and, wherein, when the inner housing is in the open position, the pocket can be accessed from outside the small item dispenser without small items being able to enter the pocket from the main cavity.

9. A small item dispenser according to claim 8, wherein the outer housing includes a dispensing opening configured to communicate with the pocket when the inner housing is in the open position.

10. A small item dispenser according to claim 8, wherein the inner housing is removably coupled to the outer housing to allow loading of small items into the main cavity.

11. A small item dispenser according to claim 8, wherein the pocket is sized to receive and hold at most one small item.

12. A small item dispenser according to claim 8, wherein the inner housing is biased toward a closed position with respect to the outer housing.
